(19) United States
(12) Patent Application Publication
(10) Pub. No.: US 2026/0072411 A1
(43) Pub. Date: Mar. 12, 2026

(54) WATCHCASE WITH CAPSULE

(71) Applicant: ETA SA Manufacture Horlogère Suisse, Grenchen (CH)

(72) Inventors: Roger WILLEMIN, Grenchen (CH); Martial BRINGOLF, Le Landeron (CH)

(73) Assignee: ETA SA Manufacture Horlogère Suisse, Grenchen (CH)

(21) Appl. No.: 19/286,757

(22) Filed: Jul. 31, 2025

(30) Foreign Application Priority Data
Sep. 9, 2024 (EP) 24199221.3

(51) Int. Cl. G04G 17/08; G04G 17/04

(52) U.S. Cl. CPC G04G 17/08; G04G 17/04

(57) ABSTRACT

A watchcase (1) including a middle (3), a capsule (2) assembled with a bayonet connector in the middle (3) and a bolt (16) fitted on the bayonet connector to lock any relative rotation between the capsule (2) and the middle (3), the capsule (2) including: a container (4) for holding a movement and a detachable source of electrical energy; a back (6) and a glass (8) respectively closing the container (4) with the back (6) indexed to the container (4) to prevent any relative rotational movement between the back (6) and the container (4) ; and a water-resistant joint (5) between the container (4) and the back (6).

### CROSS REFERENCE TO RELATED APPLICATIONS

This application claims priority to European Patent Application No. 24199221.3 filed September 9, 2024, the entire contents of which are incorporated herein by reference.

### TECHNICAL FIELD OF THE INVENTION

The invention relates to a watchcase suitable for an electronic watch, optionally a smartwatch. More specifically, it relates to a watchcase comprising a middle and a water-resistant capsule assembled with a bayonet connector.

### Technological background

Portable electronic items can be powered by one or more detachable energy sources, such as batteries, accumulators or cells.

For example, electronic, or electromechanical, watches are powered, at least in part where electromechanical watches are concerned, by a detachable source of electrical energy, for example a button cell, embedded in a compartment in the watchcase. A detachable cover is provided to enclose the cell inside the compartment, guaranteeing that the compartment is at least water-resistant.

To ensure easy replacement of the cell, the cover and the case usually feature quick-release rotational coupling/uncoupling means that enable ready access to the cell and quick fastening of the compartment once the cell has been replaced. Examples of these quick-release coupling/uncoupling means are quarter-turn-type assembly systems or bayonet-type assembly systems.

In addition, the cover can have an impression on its outer surface configured to receive the end of a tool so that the cover can be rotated. To make cell replacement even easier, this impression often has a relatively simple, common shape, such as a slot, so that various accessories readily available to the wearer can be used to open the compartment with no need for a specific tool or to take the watch to a horologist to have the cell replaced.

However, these various interesting and advantageous technical solutions for replacing the cell can also have drawbacks in some situations, particularly if they are handled by children, especially young children. Indeed, these young children might manage to remove the cell cover and access the cell compartment, resulting in a risk of swallowing the cell, with all the serious consequences that could entail.

Accordingly, there is a need to secure watchcases to prevent unauthorised access to the cell compartment, particularly by young children, while keeping the benefits of quick and easy cover removal.

### SUMMARY OF THE INVENTION

The present invention provides a watchcase design that makes it possible to secure the access to an accumulator or to a cell.

According to the invention, the watchcase results from the assembly of a water-resistant capsule and of a middle. by means of a bayonet connector. The water-resistant capsule comprises a container holding the movement and the detachable electrical energy source, a glass and a back respectively closing the container. Inside the capsule, the back is mounted in a given position relative to the container. In other words, it is indexed to the container. The entire assembly is secured by a bolt that keeps the capsule from rotating relative to the middle.

More specifically, the invention relates to a watchcase comprising a middle, a capsule assembled with a bayonet connector in the middle and a bolt fitted on the bayonet connector to lock any relative rotation between the capsule and the middle, said capsule comprising:

-a container for holding a movement and a detachable source of electrical energy,

-a back and a glass respectively closing the container with said back indexed to the container to prevent any relative rotational movement between the back and the container,

-a water-resistant joint between the container and the back.

This arrangement enables the electrical energy source to be placed inside a capsule with bolting means that prevent access to the energy source without specific tools. This makes it possible to assemble and disassemble a watchcase, while providing secure access to the accumulator or cell.

In addition, the capsule system enables the back to be indexed to a container. This indexing offers a significant advantage for smartwatches. Indeed, during assembly, the back fitted with the sensors is kept in position relative to the container containing the movement. This means that no relative movement is possible between the back and the movement during assembly. Accidental disconnection between the sensors and the movement is thus prevented, as the connection can be made using a flex, a pogo, a wire, etc. Similarly, mounting the sensors inside a capsule before assembly with the middle allows for pre-testing.

The following is another advantage of this capsule assembly. Designs with different middles can be created separately from the capsule while using the same capsule. To keep costs down, plastic can also be combined with metal, for example making a plastic capsule and a metal middle.

### BRIEF DESCRIPTION OF THE FIGURES

FIG. 1 shows an exploded view of the three parts of the capsule according to the invention with the movement and the cell to be positioned inside the capsule.

FIG. 2 shows a three-dimensional view of the mounted capsule.

FIG. 3 shows a three-dimensional view of the capsule and the middle on which the capsule is to be bayonet-mounted.

FIG. 4 shows a three-dimensional view of the capsule bayonet-mounted on the middle with the glass in the raised position, in contrast to the previous figures.

FIG. 5 shows a variant of the bolt according to the invention for rotationally locking the capsule relative to the middle.

FIGS. 6a and 6b are partial vertical cross-sectional views of the capsule and middle assembly at the bolt and at the bayonet connector, respectively.

FIG. 7 is a partial view of the capsule and middle assembly with only the middle and bolt shown.

### DETAILED DESCRIPTION OF THE INVENTION

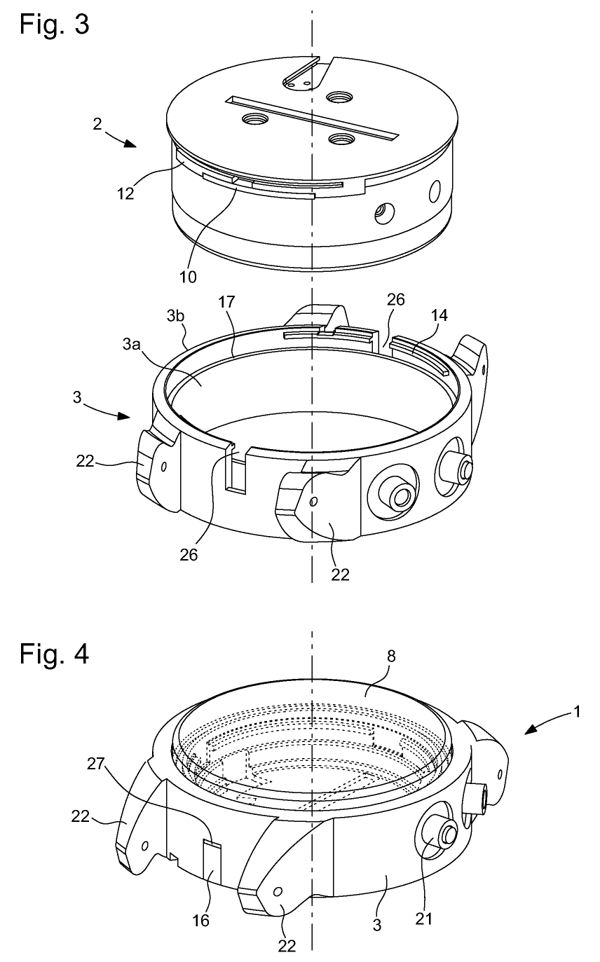

The invention relates to a watchcase 1 more specifically suitable for an electronic watch, or even a smartwatch. It comprises two parts formed by a water-resistant capsule 2 and a middle 3 (FIG. 3). According to the invention, the capsule and the middle are assembled with a bayonet connector. By way of example, the capsule, excluding the glass and joint, can be made of a synthetic material such as plastic or of a metallic material, and the middle can be made of the same material or of a different material.

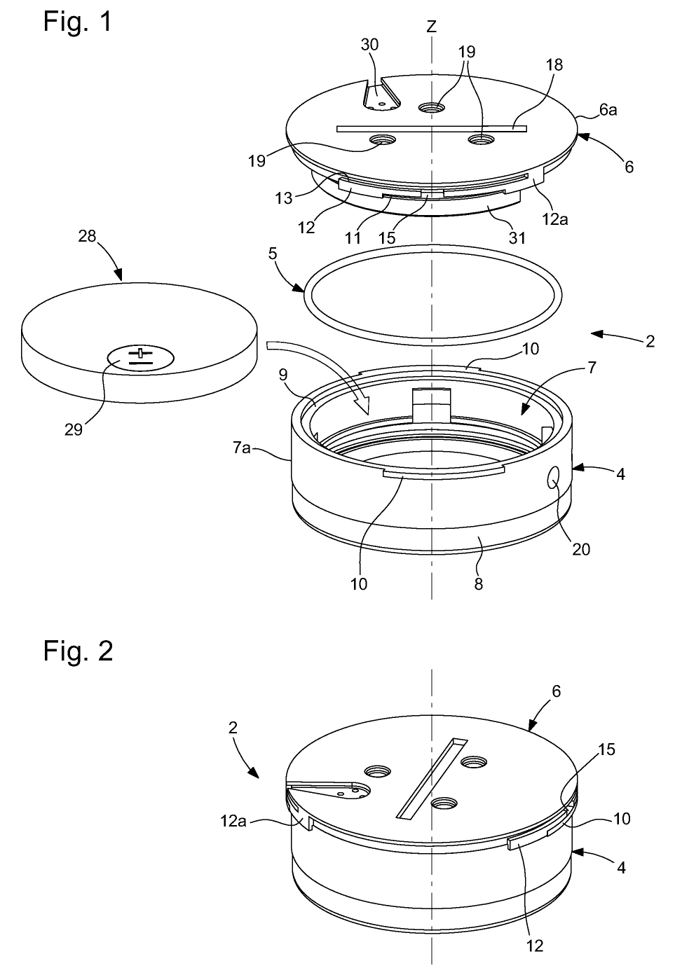

The capsule 2, which can be seen in FIG. 1, comprises a container 4, a joint 5, such as an O-ring, ensuring the water-resistance of the capsule, and a back 6 with the three parts assembled along an axis Z. The container 4 comprises a bed 7, for example cylindrical in shape, intended to hold a movement 28 and a detachable source of electrical energy 29 such as a cell. This bed 7 is closed at the front by a glass 8 that can, for example, be secured by hot soldering or ultrasonic soldering, and at the rear by the back 6. The container 4 is made in one piece with openings 20 for the control buttons 21 (FIG. 4), with joints (not shown) to ensure water-resistance.The back 6 has a slot 18 or circular orifices 19 on its face designed for accessibility after assembly, to accommodate tools for mounting the capsule on the middle and removing it therefrom. The back 6 can also comprise sensors 30 on a smartwatch. The back 6 can also include a movement support 31.

The bed 7 of the container 4 is enclosed by a lateral wall 7a. The inner outline of this wall is recessed at its lower end to form a rim 9 that supports the joint 5 and the back 6. “Lower position” refers to the position towards the back, that is, towards the rear, as opposed to the upper position, which is turned towards the glass, that is, towards the front.

The lateral wall 7a comprises at its lower end at least one protruding portion 10, also referred to as a flange, radially disposed towards the outside of the container 4. In the example shown, there are 2 diametrically opposite flanges. Their purpose is to index the back 6 on the container 4. To this end, the back 6 comprises countersinks 11 with dimensions similar to those of the flanges 10 in which the latter are embedded. These countersinks 11 are formed in flanges 12 on the back 6 extending in a circular arc around the periphery 6a of the back 6. These flanges 12 are each traversed by a groove 13 used for the bayonet connection. The grooves 13 are open at one end of the circular arc to allow the flanges 14 protruding inside the middle 3 to engage (FIG. 3) and are optionally closed at the other end by a stop 12a formed by the portion of material extending along the axis Z from the periphery 6a. From the stop 12a towards the open end of the flange 12, the latter moves, preferably gradually, away from the periphery 6a of the back to form an access ramp for the flange 14.

The middle 3, which can be seen in FIG. 3, comprises a through bed 3a for holding the capsule 2. On its inner outline, a rim 17 is recessed on which the upper end of the flange 10 is supported. Between this rim 17 and the lower end 3b of the middle 3 are the flanges 14 of the bayonet connector, of which there are 2, diametrically opposed in the example shown. One end of the flange 14 is designed to be fitted over the ramp of the flange 12 on the back up to its stop position against the stop 12a when there is a stop. FIG. 6b shows a cross-sectional view of this bayonet connection, with the flange 14 on the middle 3 engaged in the groove 13 in the back 6.

The bayonet connector is bolted with a bolt 16, which is an attachment or optionally a part secured to the back. In the example shown, this is a part attached to the middle 3 and to the capsule 2. To this end, the groove 13 in the back 6 communicates with a notch 15 in the flange 12. For example, the notch 15 also opens onto the countersink 11. The notch 15 is designed to be positioned facing an opening 26 made in the wall of the middle 3 to jointly receive the bolt 16 that keeps the capsule 2 from rotating relative to the middle 3 after assembly (FIG. 4). Said opening 26 runs through the wall of the middle at the flange 14, optionally in the middle of the flange 14. Preferentially, the bolt 16 is positioned between the horns 22 of the middle 3 so as to be concealed once the wristlet has been attached.

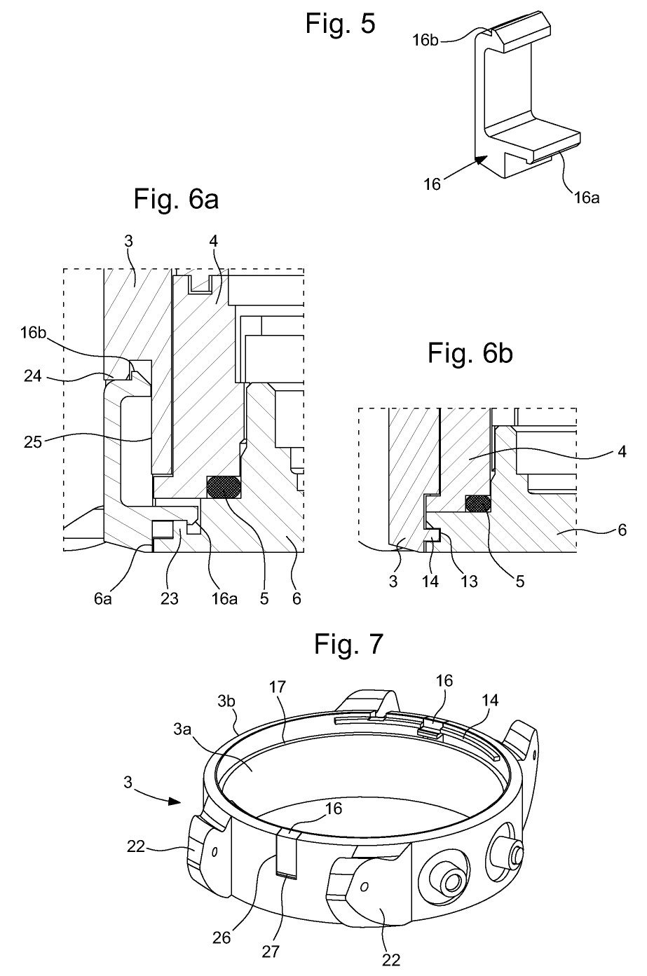

As shown in FIG. 5, the bolt 16 for rotationally locking the capsule relative to the middle. can be a clip that is embedded in the notch 15 on the back 6 and in the opening 26 of the middle 3. The clip 16 comprises two hooks 16a, 16b that hook onto a catch 23 on the back 6 and a shoulder 24 on the middle 3, the clip being supported on the perimeter 6a of the back and on a face 25 on the middle facing the shoulder 24 (FIG. 6a). This clip can be made of synthetic material or of a metal material and, for example, of the same material as the middle. To withdraw the bolt, a tool (not shown) is positioned from the outside of the middle in the interstice 27 formed between the bolt 16 and the outer wall of the middle 3 (FIG. 4).

The watchcase is assembled as follows. The joint 5 is placed on the rim 9 of the container 4 and the back 6 is placed along the axis Z on the container 4 with the positioning of the flanges 10 of the container 4 in the recesses 11 of the back 6 ensuring indexing. The mounted capsule 2 is then placed within the recess 3a of the middle 3 with the flanges 12 positioned on the rim 17 of the middle 3 in the regions without the flanges 14. Then, by rotating the capsule 2 relative to the middle 3 using a tool in the slot 18 or in the orifices 19, one end of the flange 14 engages the open end of the groove 13. The bolt 16 is then embedded in the notch 15 and the opening 26, thereby blocking any rotation of the capsule 2 relative to the middle 3. To disassemble the assembly, a tool is positioned from the outside of the middle in the interstice 27 formed between the bolt 16 and the outer wall of the middle 3 (FIG. 4).

1. A watchcase (1) comprising a middle (3), a capsule (2) assembled with a bayonet connector in the middle (3) and a bolt (16) fitted on the bayonet connector to lock any relative rotation between the capsule (2) and the middle (3), said capsule (2) comprising:
a container (4) for holding a movement (28) and a detachable source of electrical energy (29),
a back (6) and a glass (8) respectively closing the container (4) with said back (6) indexed to the container (4) to prevent any relative rotational movement between the back (6) and the container (4),
a water-resistant joint (5) between the container (4) and the back (6).

2. The watchcase (1) according to claim 1, wherein the container (4) comprises a bed (7) for holding the movement (28) and the detachable electrical energy source (29), said bed (7) being enclosed by a lateral wall (7a) comprising, on its end turned towards the back (6), at least a first flange (10) radially disposed towards the outside of the container (4), the back (6) comprising at least one countersink (11) accommodating said first flange (10) for indexing the back (6) to the container (4).

3. The watchcase (1) according to claim 1, wherein the back (6) comprises on its periphery (6a) at least a second flange (12) traversed by a groove (13) and wherein the middle (3) comprises at least a third flange (14) protruding inside said middle (3), said groove (13) being open at one end to enable the third flange (14) to engage when the capsule (2) is rotated, and optionally closed at the other end by a stop (12a) to stop the rotation, the engagement of the third flange (14) in the groove (13) forming the bayonet connection.

4. The watchcase (1) according to claim 1, wherein the stop (12a) is formed by a portion of material extending toward the capsule (4) from the periphery (6a) of the back (6).

5. The watchcase (1) according to claim 3, wherein the second flange (12) gradually moves radially away from the periphery (6a) of the back (6) to the open end of the groove (13) so as to form an access ramp for the third flange (14).

6. The watchcase (1) according to claim 3, wherein the bolt (16) is a flexible part attached to the middle (3) and to the capsule (2), an opening (26) being made through the third flange (14) and the groove (13) communicating with a notch (15) made in the second flange (12), said notch (15) being positioned facing the opening (26) to jointly receive the bolt (16).

7. The watchcase (1) according to claim 1, wherein the bolt (16) is a clip.

8. The watchcase (1) according to claim 1, wherein the clip comprises two hooks (16a, 16b) that respectively hook onto a catch (23) on the back (6) and a shoulder (24) on the middle (3).

9. The watchcase (1) according to claim 6, wherein the notch (15) opens onto the countersink (11).

10. The watchcase (1) according to claim 6, wherein an interstice (27) is formed between the bolt (16) and the middle (3) to enable the introduction of a first tool for withdrawing the bolt (16).

11. The watchcase (1) according to claim 1, wherein the bolt (16) is positioned between the horns (22) of the middle (3).

12. The watchcase (1) according to claim 1, wherein the back (6) and the container (4) are made of a synthetic material.

13. The watchcase (1) according to claim 1, wherein the middle (3) is made of a different material than the back (6) and the container (4).

14. The watchcase (1) according to claim 1, wherein the back (6) comprises on its visible face a second slot (18) or orifices (19) for positioning a second tool for mounting and removing the back (6) relative to the middle (3).

15. The watchcase (1) according to claim 1, wherein the back (6) comprises one or more measurement sensors (30).
